(19) United States
(12) Patent Application Publication
(10) Pub. No.: US 2004/0098250 A1
(43) Pub. Date: May 20, 2004

(54) Semantic search system and method

(76) Inventors: Gur Kimchi, New York, NY (US); Meyrav Kimchi, New York, NY (US)

Correspondence Address: Gur Kimchi, APT 5C, 44 EAST 12 STREET, New York, NY, 10003, US

(21) Appl. No.: 10/299,153

(22) Filed: Nov. 19, 2002

(51) Int. Cl. G06F 17/27

(52) U.S. Cl. 704/9

(57) ABSTRACT

A system and method is described for the effective implementation of a search method using a semantic-space. Said system comprising primarily of a semantic-model, training phase using reliable information, and a semantic-space search method. The system and method described enable contextual search with improved properties over non-semantic methods.

### FIELD OF INVENTION

The present invention relates generally to the field of data indexing and searching. More specifically, the present invention describes to a generic system for searching textual documents using a semantic search method.

### BACKGROUND OF THE INVENTION

In classic search systems a “spider” process traverses an information tree, feeding information to an index. Common words (such as “is”, “a”) are commonly skipped as value is only seen in the material being searched, not the semantic inter-relationship, and therefore the index usually comprises of root words linked to where they reside, many times in the form of a uniform resource locator (a URL).

The main limitation of such a system is that no understanding of the semantic relations is retained in the search domain, as only root words and symbols are being searched for. When searching for more then one word, the sequence and distance of the words are compared, to provide a more suitable presentation form to the user. In the best search systems deployed on the Internet and private networks today, exemplified by the “google” (www.google.com) service, reverse link analysis is performed to add a degree of “popularity” to the result-set order and improve search results over other systems (such as Alta Vista, at www.altavista.com).

Additionally, existing search methods and systems do not include a training period using controlled data-sources and the resulting reliability ranking system to insure the system can differentiate between reliable and less-reliable information.

### SUMMARY OF THE INVENTION

This invention presents a revolutionary advancement for search systems and methods.

Under the described system, Spiders do not simply parse retrieved documents and update index pointers, but provide the original text to a natural-language parser that breaks down the text to tokens and relationships. Such a parser is known in the art, and described in U.S. Pat. Nos. 5,878,386 and 5,331,556 among others. Commercial parsers are available today to perform this natural-language to tokens/relationships mapping. This art is generally used in the machine-language-translation domain.

In systems using this invention, the tokens/relationships form provided by the parser is converted directly to a semantic-schema, referred to as the “semantic-compiled-form”, representing the original roots and their inter-relationships directly, encoded as a network model, where tokens present the “islands” of the network, and the relationships the links between islands.

The search system is initialized by feeding the model with controlled information, such as intra-language dictionaries, inter-language dictionaries, thesaurus databases, encyclopedias and other “trusted” and “high-confidence” forms of information. This is done before exposing the system to uncontrolled information. This initial “training” phase is given a high degree of “reliability rank” for tokens and their relationships.

As the entire index is semantically-compiled and is based on a network-schema model, as additional “public” information is found and added in compiled semantic-form to the index (using a standard spider process), it will naturally attach to existing tokens and relationships. A “reliability rank” system is maintained comparing new relationships to existing relationships and their “reliability rank”, and when mismatches are found compared to existing “high-reliability” information, the reliability rank may be modified.

When a user enter a search term(s) to perform a search, these search terms are (a) parsed and converted to the semantic-compiled-form, (b) a point of origin is searched for each search term and relationship and (c) an analysis based on token-distance/minimal-cost, relationship-distance/minimal-cost and confidence-ranking is performed to locate a list of semantic-space matches. (d) This result-set directly points to documents with a similar “semantic-map” as contained in the original search terms, organized by distance (close to far) and confidence (high-to-low) order. The document links, using URLs or other method are (e) then presented to the user as the search results.

One of the primary advantages of semantic-compiled-form search is that it is inherently language and synonym agonistic, due to the fact that the core of the index may contain language to language mapping and a thesaurus, searching for synonym terms is just considered a direct “distance” reply from the original search term, and will show up in the search result—as the semantic-maps for same words in different languages or word synonyms will be “close” to each other.

### BRIEF DESCRIPTION OF THE DRAWINGS

FIG. 1 illustrates a semantic-compiled-form or semantic-map for a simple sentence.

FIG. 2 illustrates a semantic-compiled-form or semantic-map for a more complex paragraph.

FIG. 3 illustrates a semantic-compiled-form or semantic-map of FIG. 1 with the addition of third paragraph and a language-translated word, showing the combined semantic-map of these three separate sources.

FIG. 4 illustrates the semantic-compiled-form or semantic-map for the partial Thesaurus data for the word “IS”.

### DESCRIPTION OF THE PREFERRED EMBODIMENTS

While this invention is illustrated and described in a preferred embodiment, the system may be produced in many different configurations, forms and materials. There is depicted in the drawings, and will herein be described in detail, a preferred embodiment of the invention, with the understanding that the present disclosure is to be considered as a exemplification of the principles of the invention and the associated functional specifications of the materials for its construction and is not intended to limit the invention to the embodiment illustrated. Those skilled in the art will envision many other possible variations within the scope of the present invention.

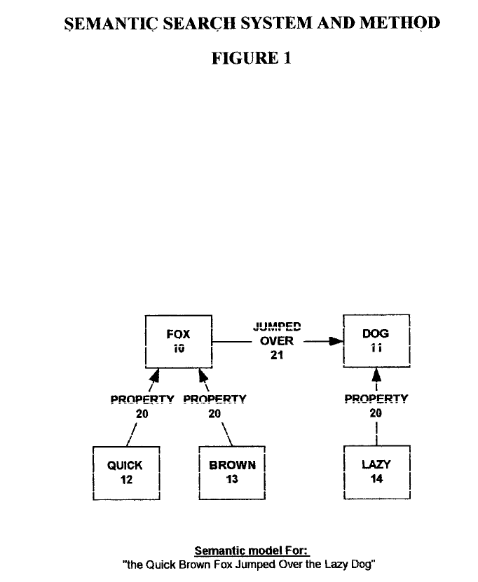

FIG. 1 illustrates a sample semantic-compiled-form (e.g. semantic-map) for the sentence: “the quick brown fox jumped over the lazy dog”. The map was created by first fetching the text using an HTTP spider or other means, passing the text via a language analyzer and placing the resulting token/relationship map in a network-model database.

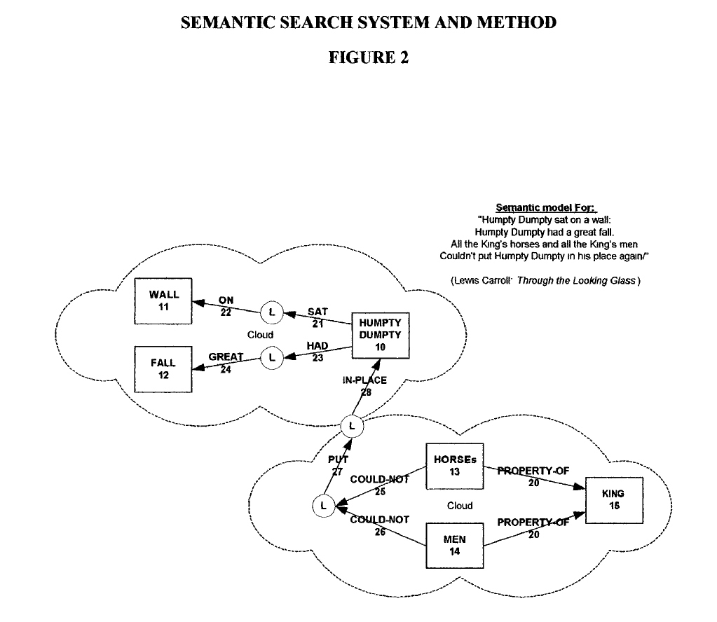

FIG. 2 illustrates a sample semantic-compiled-form (e.g. semantic-map) for a more complex paragraph: “Humpty Dumpty sat on a wall: Humpty Dumpty had a great fall. All the King's horses and all the King's men Couldn't put Humpty Dumpty in his place again” (Lewis Carroll: Through the Looking Glass). The map was created using the same procedures as for FIG. 1.

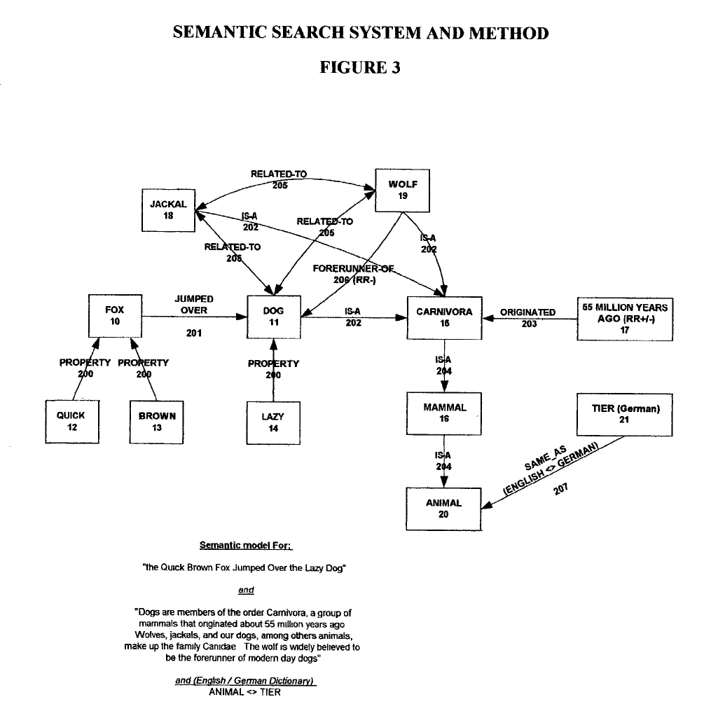

FIG. 3 illustrates a sample semantic-compiled-form (e.g. semantic-map) for the map described in FIG. 1, and adding the paragraph: “Dogs are members of the order Carnivora, a group of mammals that originated about 55 million years ago. Wolves, jackals, and our dogs, among others animals, make up the family Canidae. The wolf is widely believed to be the forerunner of modern day dogs” and the English-German dictionary translation for the word “Animal” —“Tier” in the German Language.

The map was created using the same procedures as for FIG. 1. The combined semantic map now contains a 205 RELATED-TO relation the 11 DOG token and the 19 WOLF, and 18 JACKAL tokens. The map also contains a 202 IS-A relation to the 15 CARNIVORA token. The 206 FORERUNNER-OF relation is given a lower Reliability Rank (206 RR-) because of the “. . . widely believed . . . ” word usage in the original text.

A sample search term “what is a Wolf?” compiled into a semantic-map will match closely the 19 WOLF token, find the immediate 202 IS-A relation (based on vector distance) to 15 CARNIVORA, so documents with this semantic-map will be returned. Next based on shortest vector-distance the 205 RELATED-TO relations to 11 DOG and 18 JACKAL is found, returning documents with similar IS-A relations to 11 DOG and 18 JACKAL, next an 204 IS-A relationship is found between 15 CARNIVORA and 16 MAMMAL, so documents matching the semantic map for “what is a CARNIVORA” are returned, and so forth.

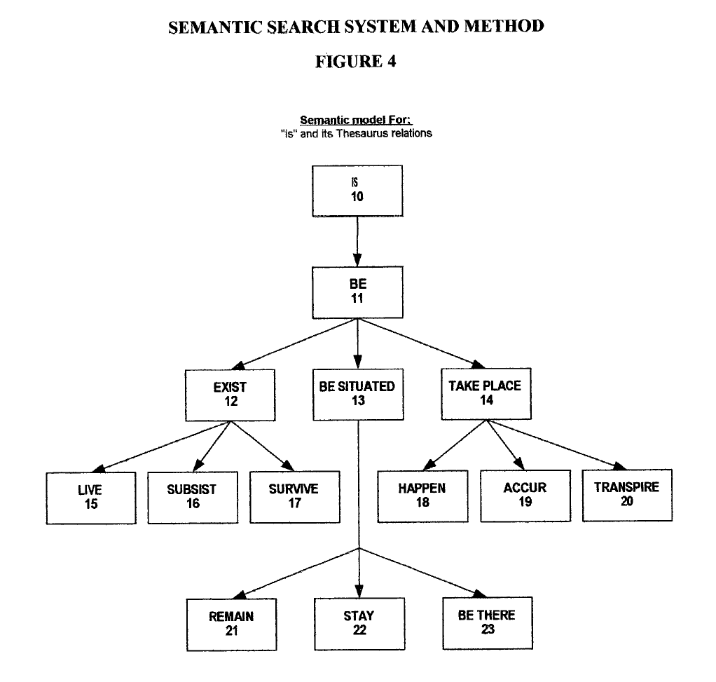

While the preferred embodiment uses the concepts of “Tokens” and “Relations”, these are for convenience only, as these concepts can be used interchangeably. FIG. 4 illustrates part of the semantic-map created by feeding a Thesaurus into the system, for the token 10 IS. By training the system using such relevant information, semantic-relations become part of the baseline semantic-map with high Reliability Ranking, making the system flexible when by enabling searching for the context—rather then the words in the text of the user query.

The semantic search method described can also be used with without a training period, resulting at lower performance, but still higher performance then existing methods.

The training and the reliability ranking method described can also be used with conventional search engines, without the use of a semantic model, resulting at lower performance, but still higher performance then existing methods

### CONCLUSION

A system and method has been shown in the above embodiments for the effective implementation of a search system and method based on a semantic model, using a training period, a reliability ranking model and a semantic search method. The described system and method provides users performing search operations on text and other language-compatible data where said search matches the language context of the user query rather then words in a index.

I Claim:

1. A system and method of searching comprising the following steps:
creating a network semantic model;
adding additional information to the model from text sources; and
performing semantic-space search operations on said model;

2. A system and method of searching comprising the following steps:
creating a network semantic model;
training the model with initial information;
adding additional information to the model from text sources; and
performing semantic-space search operations on said model;

3. A system and method of searching comprising the following steps:
creating a network semantic model;
adding additional information to the model from text sources;
accepting search requests, compiling said search request into a semantic-map; and
performing semantic-space search operation on said model using said compiled search requests;

4. A system and method of searching comprising the following steps:
creating a network semantic model;
training the model with initial information;
adding additional information to the model from text sources;
accepting search requests, compiling said search request into a semantic-map; and
performing semantic-space search operations on said model using said compiled search requests;

5. A method for improving search engines by:
training said search engine with controlled information; and
using a reliability ranking system.

6. A system and method of searching comprising the following:
a semantic model;
a method for retrieving information from a given information space (such as the internet);
a method for converting said information into semantic-form;
a method for accepting search requests;
a method for converting said search requests into semantic-form; and
a method for comparing the semantic form of the search requests to the semantic-model and returning matching information in order of relevance.

7. A System and method of searching comprising the following:
a semantic model;
a training phase using reliable information;
a method for retrieving information from a given information space (such as the internet);
a method for converting said information into semantic-form;
a method for accepting search requests;
a method for converting said search requests into semantic-form; and
a method for comparing the semantic form of the search requests to the semantic-model and returning matching information in order of relevance.
